(19) United States
(12) Patent Application Publication
(10) Pub. No.: US 2024/0419975 A1
(43) Pub. Date: Dec. 19, 2024

(54) Method of providing a representation of temporal dynamics of a first system, middleware systems, a controller system, computer program products and non-transitory computer-readable storage media

(71) Applicant: IntuiCell AB, STOCKHOLM (SE)

(72) Inventors: Henrik Jörntell, Lund (SE); Jonas Enander, Linköping (SE); Gerald E. Loeb, South Pasadena, CA (US)

(21) Appl. No.: 18/822,333

(22) Filed: Sep. 2, 2024

Related U.S. Application Data
(63) Continuation of application No. PCT/SE2023/050185, filed on Mar. 1, 2023.
(60) Provisional application No. 63/315,694, filed on Mar. 2, 2022.

(51) Int. Cl. G06N 3/088; G06N 3/044

(52) U.S. Cl. CPC G06N 3/088; G06N 3/044

(57) ABSTRACT

A method of providing a representation of temporal dynamics of a first system comprising sensors by using a middleware system. The middleware system includes two or more network nodes. A first set of the two or more network nodes are connectable to the sensors, the method includes: receiving activity information from the sensors indicative of the temporal dynamics of the first system, wherein the activity information evolves over time; applying a set of unsupervised learning rules to each of the one or more network nodes; learning a representation of the temporal dynamics of the first system by organizing the middleware system in accordance with the received activity information and in accordance with the applied sets of unsupervised learning rules; and providing the representation of the temporal dynamics of the first system. A middleware system, a controller system, computer program products and non-transitory computer-readable storage media are also described.

### TECHNICAL FIELD

The present disclosure relates to a method of providing a representation of temporal dynamics of a first system, middleware systems, a controller system, computer program products and non-transitory computer-readable storage media. More specifically, the disclosure relates to a method of providing a representation of temporal dynamics of a first system, middleware systems, a controller system, computer program products and non-transitory computer-readable storage media as defined in the introductory parts of the independent claims.

### BACKGROUND ART

Controllers or control systems, such as PID controllers are known. Furthermore, automatic control systems are known. Moreover, some work regarding neural networks and controlling robots has been done (refer e.g., to Ali Marjaninejad et. al., “Autonomous functional movements in a tendon-driven limb via limited experience”, In: nature machine intelligence).

However, it may be difficult for the control system to learn to control a plant or another system (having sensors and possibly actuators), especially if there is compliance in the plant, which is the case in e.g., soft robotics (i.e., systems comprising robots composed of compliant materials).

Thus, there may be a need for a method and/or a system for facilitating for a controller to learn how to control a plant or another system. Furthermore, there may be a need for an improved, simplified control system (e.g., a controller with lower complexity).

Preferably, such methods/systems provide or enable one or more of improved performance; quicker, more robust and/or versatile adaptation; increased efficiency; use of less computer power; use of less storage space; less complexity and/or use of less energy.

### SUMMARY

An object of the present disclosure is to mitigate, alleviate or eliminate one or more of the above-identified deficiencies and disadvantages in prior art and solve at least the above-mentioned problem(s).

According to a first aspect there is provided a computer-implemented or hardware-implemented method of providing a representation of dynamics and/or time constants of a first system comprising sensors and actuators by utilizing a middleware system connected or connectable to a controller system, the middleware system comprising two or more network nodes and one or more output nodes, wherein the two or more network nodes are connected to the one or more output nodes, and wherein the one or more output nodes are connected or connectable to the actuators, and wherein the one or more network nodes and/or the one or more output nodes are connected or connectable to the sensors, the method comprising: receiving sensory feedback indicative of the dynamics and/or the time constants of the first system; learning a representation of the dynamics and/or the time constants of the first system by applying unsupervised, correlation-based learning to the middleware system and generating an organization of the middleware system in accordance with the received sensory feedback; and providing a representation of the dynamics and/or the time constants of the first system to the controller system. By learning a representation of the dynamics, e.g., temporal dynamics, and/or the time constants of the first system by applying unsupervised, correlation-based learning to the middleware system and generating an organization of the middleware system in accordance with the received sensory feedback, the learning in each network/output node is made independent of learning in other nodes and each node is made more independent of the other nodes, and a higher precision is obtained. Thus, a technical effect is that a higher precision/accuracy is achieved/obtained. Furthermore, longer time series can be recognized/identified and/or a higher quality of learning is achieved, e.g., a larger capacity of the network is achieved. Thus, the precision/accuracy is improved/increased.

In some embodiments, the learning is used to generate the organization, in other words, the middleware is self-organizing based on the learning.

According to some embodiments, the two or more network nodes and the one or more output nodes form a recursive network or a recurrent neural network. By utilizing a recursive/recurrent neural network, dynamic behaviour over longer time periods can be tracked and dynamic behaviour over a wider range can thus be learnt, thereby increasing accuracy and/or the range in which dynamic features of the first system can be identified/recognized.

According to some embodiments, the two or more network nodes forms a recursive network or a recurrent neural network.

According to some embodiments, further the method further comprises providing an activity injection to the network nodes and/or the output nodes, thereby exciting the actuators of the first system.

According to some embodiments, the controller system is a neural network (NN) controller. Thereby, a higher number of (independent or relatively independent) dynamic modes may be identified/recognized, thus achieving a wider/broader dynamic range of the controller system.

According to some embodiments, each of the two or more network nodes and each of the one or more output nodes comprises input weights and generating an organization of the middleware system comprises adjusting the input weights. Thereby, a higher number of dynamic modes may be identified/recognized, thus achieving a wider/broader dynamic range of the middleware/controller system.

According to some embodiments, generating an organization of the middleware system comprises separating the network nodes into inhibitory nodes and excitatory nodes.

According to some embodiments, each of the network nodes comprises a synapse and wherein applying unsupervised, correlation-based learning comprises applying a first set of learning rules to the synapse of each of the inhibitory nodes and applying a second set of learning rules to the synapse of each of the excitatory nodes, and wherein the first set of learning rules is different from the second set of learning rules. By applying a first set of learning rules to the synapse of each of the inhibitory nodes and applying a (different) second set of learning rules to the synapse of each of the excitatory nodes, each node is made more independent of the other nodes, and a higher precision is obtained. Thus, a technical effect is that a higher precision/accuracy is achieved/obtained. Furthermore, longer time series can be recognized/identified and/or a higher quality of learning is achieved, e.g., a larger capacity of the network is achieved. Thus, the precision/accuracy is improved/increased.

According to some embodiments, each of the one or more network nodes comprises an independent state memory and/or an independent time constant. With an independent state memory/time constant for each network node, a wider dynamic range, a greater diversity, learning with fewer resources and/or more efficient (independent) learning is achieved (e.g., since each node is more independent).

According to some embodiments, the first system is/comprises a telecommunication system, a data communication system, a robotics system, a mechatronics system, a mechanical system, a chemical system comprising electrical sensors and actuators, or an electrical/electronic system.

According to a second aspect there is provided a computer program product comprising instructions, which, when executed on at least one processor of a processing device, cause the processing device to carry out the method according to the first aspect or any of the above-mentioned embodiments.

According to a third aspect there is provided non-transitory computer-readable storage medium storing one or more programs configured to be executed by one or more processors of a processing device, the one or more programs comprising instructions which, when executed by the processing device, causes the processing device to carry out the method according to the first aspect or any of the above-mentioned embodiments.

According to a fourth aspect there is provided a middleware system connected or connectable to a controller system and to a first system comprising sensors and actuators, the middleware system comprising controlling circuitry configured to cause: reception of sensory feedback indicative of the dynamics and/or the time constants of the first system; learning of a representation of the dynamics and/or the time constants of the first system by application of unsupervised, correlation-based learning to each of the one or more network nodes and/or to each of the one or more output nodes and generation of an organization of the one or more network nodes and/or the one or more output nodes in accordance with the received sensory feedback; and provision of a representation of the dynamics and/or the time constants of the first system to the controller system.

According to a fifth aspect there is provided middleware system connectable to a controller system and to a first system comprising sensors and actuators, the middleware system comprising: one or more network nodes; one or more output nodes, each of the one or more output nodes is connected to the one or more network nodes, and each of the one or more output nodes is connectable to a respective actuator, and each of the one or more network nodes and/or each of the one or more output nodes are connectable to a respective sensor; and the middleware system is configured to: receive sensory feedback indicative of the dynamics and/or the time constants of the first system from the sensors; learn a representation of the dynamics and/or the time constants of the first system by applying unsupervised, correlation-based learning to each of the one or more network nodes and/or each of the one or more output nodes and generating an organization of the one or more network nodes and/or each of the one or more output nodes in accordance with the received sensory feedback; and provide a representation of the dynamics and/or the time constants of the first system to the controller system.

According to a sixth aspect there is provided a controller system configured to: learn a representation of dynamic components of a middleware system; generate one or more control actions for controlling a first system based on the representation of the middleware system.

According to some embodiments, the controller system is further configured to receive a representation of the dynamics and/or the time constants of the first system from the middleware system and the generation of one or more control actions for controlling the first system is further based on the representation of the first system.

According to some embodiments, the first system is a mechanical system comprising a plurality of sensors and the information input to the neural domain of the middleware system comprises temporal dynamics information for the plurality of sensors.

According to some embodiments, the controller system comprises a model-based controller or a neural network (NN) controller.

According to some embodiments, learning a representation of dynamic components of the middleware system comprises reinforcement learning. Thereby, the learning is improved/speeded up and/or the precision/accuracy is improved/increased.

According to some embodiments, learning a representation of dynamic components of the middleware system comprises model learning. Thereby, the controller system may utilize model-based control and may be made more versatile, i.e., applicable to a higher number of circumstances/situations and thus to a wider dynamic range.

According to a seventh aspect there is provided a second system comprising the middleware system of the fourth or fifth aspects and the controller system of the sixth aspect or any of the above mentioned embodiments (related to the controller system).

According to an eighth aspect there is provided a method of providing a representation of temporal dynamics of a first system comprising sensors by utilizing a middleware system connected or connectable to a controller system, the middleware system comprising two or more network nodes, a first set of the two or more network nodes are connectable to the sensors, the method comprising: receiving activity information from the sensors indicative of the temporal dynamics of the first system, the activity information evolves over time; applying a set of unsupervised learning rules to each of the one or more network nodes; learning a representation of the temporal dynamics of the first system by organizing the middleware system in accordance with the received activity information and in accordance with the applied sets of unsupervised learning rules; and providing the representation of the temporal dynamics of the first system to the controller system.

According to some embodiments, the first system further comprises actuators and the middleware system further comprises an activity pattern generator, the method further comprising: generating, by the activity pattern generator, an activity pattern; providing the activity pattern to the actuators, thereby exciting the actuators of the first system; and organizing the middleware system is performed in accordance with the generated activity pattern.

According to some embodiments, the two or more network nodes form a recursive network or a recurrent neural network.

According to some embodiments, the controller system is a neural network (NN) controller. Thereby, a higher number of dynamic modes may be identified/recognized, thus achieving a wider/broader dynamic range of the controller system.

According to some embodiments, each of two or more network nodes comprises input weights and organizing the middleware system comprises adjusting the input weights.

According to some embodiments, applying a set of unsupervised learning rules to each of the one or more network nodes comprises updating the input weights of each network node based on correlation of each input of the node with the output of the node.

According to some embodiments, generating an organization of the middleware system comprises separating the network nodes into inhibitory nodes and excitatory nodes.

According to some embodiments, each of the network nodes comprises a synapse and applying a set of unsupervised learning rules to each of the one or more network nodes comprises applying a first set of learning rules to the synapse of each of the inhibitory nodes and applying a second set of learning rules to the synapse of each of the excitatory nodes, and wherein the first set of learning rules is different from the second set of learning rules.

According to some embodiments, each of the one or more network nodes comprises an independent state memory or an independent time constant.

According to some embodiments, the first system is/comprises a telecommunication system, a data communication system, a robotics system, a mechatronics system, a mechanical system, a chemical system comprising electrical sensors and actuators, or an electrical/electronic system.

According to a ninth aspect there is provided a computer program product comprising instructions, which, when executed on at least one processor of a processing device, cause the processing device to carry out the method according to the eighth aspect or any of the above mentioned embodiments.

According to a tenth aspect there is provided non-transitory computer-readable storage medium storing one or more programs configured to be executed by one or more processors of a processing device, the one or more programs comprising instructions which, when executed by the processing device, causes the processing device to carry out the method according to the eighth aspect or any of the above mentioned embodiments.

Effects and features of the second, third, fourth, fifth and sixth, seventh, eighth, ninth and tenth aspects are to a large extent analogous to those described above in connection with the first aspect and vice versa. Embodiments mentioned in relation to the first aspect are largely or fully compatible with the second, third, fourth, fifth and sixth, seventh, eighth, ninth and tenth aspects and vice versa.

An advantage of some embodiments is that control by a controller is facilitated/simplified (by the middleware system), thus lowering the complexity of the controller.

A further advantage of some embodiments is that subsequent or simultaneous control learning by the controller system is facilitated/simplified (by the middleware system), thus lowering the complexity of the controller and/or speeding up the learning of the controller.

Another advantage of some embodiments is that a less complex controller (than the controller needed if the middleware was not utilized) can be utilized to control a (particular) plant/machine/system.

Yet another advantage of some embodiments is that a controller may be made more versatile and/or enabled to control much more complex systems (by utilizing the middleware system).

Yet further advantages of some embodiments are that precision/accuracy is improved/increased, dynamic behaviour over longer time periods can be tracked and dynamic behaviour over a wider range can be learnt, a wider/broader dynamic range of the controller system can be achieved, a higher number of dynamic modes may be identified/recognized, thus achieving a wider/broader dynamic range of the middleware/controller system, a wider dynamic range, a greater diversity, learning with fewer resources and/or more efficient (independent) learning is achieved.

Other advantages of some of the embodiments are improved performance; quicker, more robust and/or versatile adaptation; increased precision/accuracy; increased efficiency; less computer power needed; less storage space needed; less complexity and/or lower energy consumption.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps. Furthermore, the term “configured” or “adapted” is intended to mean that a unit or similar is shaped, sized, connected, connectable or otherwise adjusted for a purpose.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1A is a schematic block diagram illustrating a first system, a middleware system and a controller system according to some embodiments;

FIG. 1B is a flowchart illustrating method steps according to some embodiments;

FIG. 2 is a schematic block diagram illustrating a network node according to some embodiments;

FIG. 3 is a schematic block diagram illustrating an output node according to some embodiments;

FIG. 4 is a flowchart illustrating method steps according to some embodiments;

FIG. 5 is a flowchart illustrating method steps implemented in a middleware system according to some embodiments;

FIG. 6 is a flowchart illustrating method steps according to some embodiments; and

FIG. 7 is a schematic drawing illustrating an example computer readable medium according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

A recurrent neural network (RNN) is a class of artificial neural networks where connections between nodes can create a cycle, allowing output from some nodes in a layer to affect subsequent input to the nodes within the same layer. The term “recurrent neural network” is used to refer to the class of networks with an infinite impulse response.

A recursive network (RN) is a class of networks, such as artificial neural networks, where connections between nodes can create a cycle, allowing output from some nodes in a layer to affect subsequent input to the nodes in the same layer and/or affect input to nodes in other layers. The term “recursive network” is used to refer to the class of networks with an infinite impulse response. An RN may be different from a recursive neural network as defined in machine learning.

A representation of dynamics may be a set of one or more time constants. Alternatively, a representation of dynamics is an indication of one or more time constants.

A middleware system is an intermediary between two systems, which facilitates communication between the two systems (and/or control of one system by another system).

A synapse is an input unit. Each network node and/or each output node comprise one or more synapses. Each synapse comprises an input weight and is connected/connectable to an output of another network node/output node, a sensor, or an output of another system.

A sensor produces an output signal for the purpose of sensing a physical phenomenon. A sensor is a device, module, machine, or subsystem that detects events or changes in its environment and sends the information to electronics or a computing device/module/system.

An actuator is a component of a plant, machine, or system that is responsible for controlling the plant/machine/system.

Herein is referred to a “controller system”. A controller system may also be referred to as a controller or a control system. A control system manages, commands, directs, or regulates the behavior of other devices or systems by utilizing control loops.

Below is referred to a “node”. The term “node” may refer to a neuron, such as a neuron of an artificial neural network, another processing element, such as a processor, of a network of processing elements or a combination thereof. Thus, the term “network” (NW) may refer to an artificial neural network, a network of processing elements or a combination thereof.

Herein is referred to a “time constant”. Physically, the time constant represents the elapsed time required for the system response to decay to zero if the system had continued to decay at the initial rate, because of the progressive change in the rate of decay the response will have decreased in value to 1/e::::36.8% in this time (e.g., from a step decrease). In an increasing system, the time constant is the time for the system's step response to reach 1−1/e::::63.2% of its final (asymptotic) value (e.g., from a step increase). A time constant may also be referred to as a “dynamic leak”.

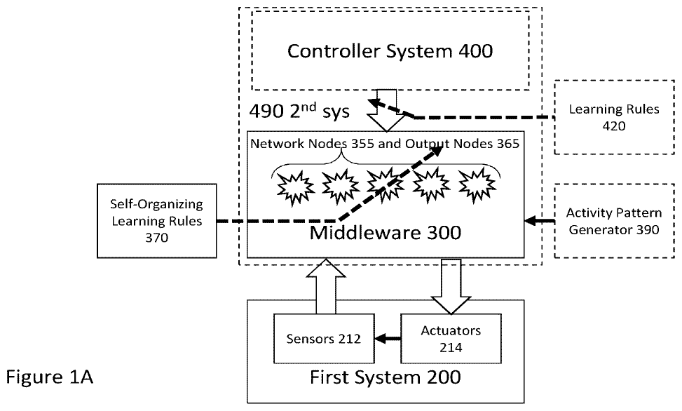

FIG. 1A illustrates a first system 200, a middleware system 300 and a controller system 400 according to some embodiments. The middleware system 300 is connected or connectable to a controller system 400. Furthermore, the middleware system 300 is connected or connectable to a first system 200. The first system 200 comprises sensors 212 and optionally actuators 214. Thus, in some embodiments, the first system is a dynamic/dynamical system. In some embodiments, the first system is a telecommunication system, a data communication system, a robotics system, a mechatronics system, a mechanical system, a chemical system comprising electrical sensors and actuators, or an electrical/electronic system.

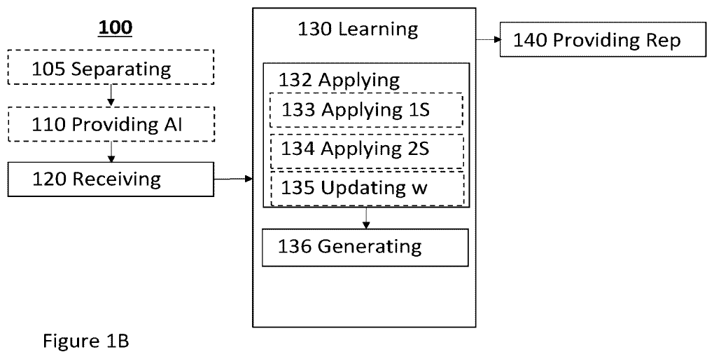

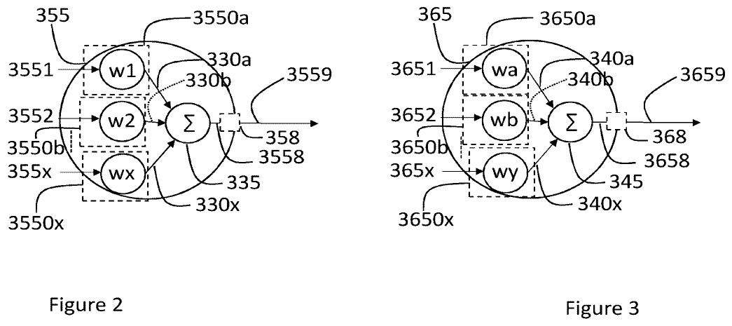

In the following, embodiments will be described where FIG. 1B illustrates a method 100 according to some embodiments. The method 100 is computer-implemented or hardware-implemented. The method 100 is a method of providing a representation of dynamics and/or time constants of the first system 200. The first system 200 comprises one or more sensors 212. In some embodiments, the first system 200 comprises one or more actuators 214. The middleware system 300 is utilized for providing the representation of dynamics and/or time constants of the first system 200. The middleware system 300 is connected or connectable to the controller system 400. In some embodiments, the controller system 400 is a neural network (NN) controller. The middleware system 300 comprises two or more network nodes 355. In some embodiments, the middleware system comprises one or more output nodes 365, which are separate from the two or more network nodes 355. In these embodiments, the two or more network nodes 355 are connected to the one or more output nodes 365. Alternatively, the two or more network nodes 355 comprises the one or more output nodes 365. Furthermore, in some embodiments, the one or more output nodes 365 are connected or connectable to the actuators 214 (i.e., the middleware 300 or one or more output nodes 365 are connectable/connected to the actuators 214 of the first system 200). Moreover, the one or more network nodes 355 (or some of them) and/or the one or more output nodes 365 (or some of them, e.g., the ones that are not connected to the actuators 214) are connected or connectable to some or all sensors 212. The method 100 comprises receiving 120 sensory feedback (from the one or more sensors 212), by the middleware 300 (e.g., by the one or more network nodes 355). The sensory feedback is indicative of the dynamics (e.g., temporal dynamics) and/or the time constants of the first system 200. In some embodiments, the sensory feedback is dependent on what the actuators 214 do, e.g., how the actuators 214 are moved or controlled and/or what state change the actuators 214 achieve. Thus, in some embodiments, the sensory feedback is a consequence of a provided activity injection. Furthermore, the method 100 comprises learning 130 a representation of the dynamics and/or the time constants of the first system 200 by applying 132 unsupervised learning to the middleware system 300 and generating 136 an organization of the middleware system 300 in accordance with the received sensory feedback. In some embodiments, the learning, 130, the applying 132 and/or the generating 136 is performed by the middleware 300. Thus, a self-organization may be performed by the middleware system 300 (based on the sensory feedback). Learning 130 a representation of the dynamics and/or the time constants of the first system 200 may alternatively be described as identifying one or more dynamic features, one or more characteristics and/or one or more time constants of the first system 200, i.e., identifying the first system 200 or building a model of the first system 200. Furthermore, in some embodiments, the applying 132 comprises applying unsupervised, correlation-based learning to the received sensory feedback. Moreover, in some embodiments, the generating 136 is performed in accordance with or based on the applying 132. The unsupervised learning may be correlation-based (e.g., comprising unsupervised and/or local learning rules that are operating independently in each node) or non-correlation-based (e.g., comprising unsupervised and/or local learning rules that are operating independently in each node). Furthermore, in some embodiments, the unsupervised learning is based on (in accordance with) correlation of each respective input of a node with the output of that node (before a threshold value is applied), e.g., based on correlation between a first input 3551 (shown in FIG. 2) to a network node 355 and an intermediate output 3558 of the same network node 355, based on correlation between a second input 3552 to the network node 355 and the intermediate output 3558 of the same network node 355 and based on correlation between a third input 355x to the network node 355 and the intermediate output 3558 of the same network node 355. Thus, in some embodiments, the unsupervised learning comprises, for each network node 355 calculating/computing a plurality of functions, each function having one of the inputs 3551, 3552, . . . , 355x of the network node 355 and the intermediate output 3558 of the network node 355 (before a threshold value is applied) as inputs to the function. Alternatively, the unsupervised learning is based on (in accordance with) correlation of each respective input 3551, 3552, 355x of a network node 355 with the output 3559 of that node (after a threshold value is applied). In some embodiments, the function is a linear function (of instant values). Alternatively, the function is a non-linear function (of instant values). As another alternative, the function comprises low-pass filtering the input 3551, 3552, . . . , 355x over a number of samples (whereas the output is/has an instant value). As yet another alternative, the function comprises leaky integrating (i.e., integrating with a leaky integrator) the input 3551, 3552, . . . , 355x and/or the output 3559 over a number of samples. The function values, i.e. each output of each function, indicates how well correlated the input 3551, 3552, 355x and the corresponding output 3558 are. This correlation is utilized for updating/adjusting the input weights w1, w2, . . . , wx of each network node 355. E.g., if the correlation between an input 3551 and the corresponding output 3558 is negative or low (lower than a threshold), the input weight w1 is increased, whereas if the correlation between an input 3552 and the corresponding output 3558 is high (higher than a threshold) or positive, the input weight w2 is decreased. Alternatively, if the correlation between an input 3551 and the corresponding output 3558 is negative or low (lower than a threshold), the input weight w1 is decreased, whereas if the correlation between an input 3552 and the corresponding output 3558 is high (higher than a threshold) or positive, the input weight w2 is increased. Additionally, or alternatively, the unsupervised learning is based on (in accordance with) correlation of each respective input of an output node 365 with the output of that same output node 365 (before a threshold value is applied), e.g., based on correlation between a first input 3651 (shown in FIG. 3) to an output node 365 and an intermediate output 3658 of the output node 365, based on correlation between a second input 3652 to the output node 365 and the intermediate output 3658 of the same output node 365, and based on correlation between a third input 365x to the output node 365 and the intermediate output 3658 of the same output node 365. Thus, in some embodiments, the unsupervised learning comprises, for each output node 365 calculating/computing a plurality of functions, each function having one of the inputs 3651, 3652, . . . , 365x of the output node 365 and the intermediate output 3658 of the output node 365 as inputs to the function. Alternatively, the unsupervised learning is based on (in accordance with) correlation of each respective input 3651, 3652, 365x of an output node 365 with the output 3659 of that node (after a threshold value is applied). The function values, i.e. the outputs of the functions, are utilized for updating/adjusting input weights of the output nodes 365 in the same manner as described above for the network nodes 355.

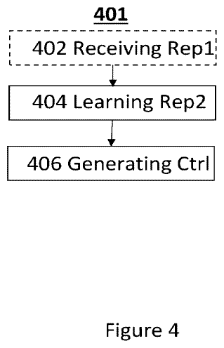

Moreover, the method 100 comprises providing 140, by the middleware 300, a representation of the dynamics and/or the time constants of the first system 200 to the controller system 400. In some embodiments, the providing 140 is based on or in accordance with the (generated) organization of the middleware 300. Furthermore, in some embodiments, the two or more network nodes 355 and the one or more output nodes 365 (together) forms a recursive network and/or a recurrent neural network. Alternatively, the two or more network nodes 355 forms a recursive network and/or a recurrent neural network (e.g., if the two or more network nodes 355 comprises the one or more output nodes 365 or the recursion may occur only between network nodes 355 and not between output nodes 365 and not between network nodes 355 and output nodes 365). As another alternative, none of the two or more network nodes 355 and none of the one or more output nodes 365 forms a recursive network or a recurrent neural network. Furthermore, in some embodiments, the middleware system 300 comprises an activity pattern generator 390 (not shown). Alternatively, the middleware system 300 is connected or connectable to an external activity pattern generator 390 (shown in FIG. 1A). In these embodiments, the method 100 may comprise providing 110 (by the middleware 300 or by the external activity pattern generator 390) an activity injection to the two or more network nodes 355 and/or the one or more output nodes 365, thereby exciting the actuators 214 of the first system 200. In order to sufficiently excite the actuators 214 for identifying (from the sensory feedback) dynamics and/or time constants of the first system 200, the provided activity injection/signal may have to have a certain energy (e.g., over/higher than an energy threshold) and/or a certain variation/variability (e.g., over/higher than a variation/variability threshold). Furthermore, in some embodiments, the provided activity injection (signal) is sent to the controller system 400. In these embodiments, the controller system 400 can utilize the provided activity injection (signal) to learn (e.g., during learning 404 described below in connection with FIG. 4) a representation of dynamic components of the middleware system 300. In some embodiments, each of the two or more network nodes 355 comprises input weights w1, w2, . . . , wx (as shown in FIG. 2). Furthermore, alternatively, or additionally, each of the one or more output nodes 365 comprises input weights wa, wb, . . . , wy (as shown in FIG. 3). In these embodiments, generating 136 an organization of the middleware system comprises adjusting one or more of the input weights w1, w2, . . . , wx, wa, wb, . . . , wy. Furthermore, in some embodiments, applying 132 unsupervised, correlation-based learning to the middleware system 300 comprises updating 135 the input weights w1, w2, . . . , wx of each network node 355, and optionally the input weights wa, wb, . . . , wy of each output node 365, based on or in accordance with correlation of each input of the network/output node 355, 365 with the output of the (same) network/output node 355, 365.

In some embodiments, before generating 136 an organization of the middleware system 300, the method comprises separating 105 the network nodes 355 (and/or output nodes 365) into inhibitory nodes and excitatory nodes (e.g., as an initialization of the middleware system 300). Each inhibitory node is configured to inhibit one or more other network nodes 355 by providing a negative output as input to the one or more other network nodes 355. Providing a negative output may be performed by adding an inverter or an inverting/sign changing processing unit to the output of the inhibitory node. Each excitatory node is configured to excite one or more other network nodes 355 by providing a positive output as input to the one or more other network nodes 355. Providing a positive output may be performed by directly feeding the output of the excitatory node to one or more other network nodes 355. Furthermore, in some embodiments, each of the network nodes 355 comprises one or more synapses or input units 3550a, 3550b, . . . , 3550x. Moreover, applying 132 unsupervised, correlation-based learning comprises applying 133 a first set of learning rules to each of the synapses 3550a, 3550b, . . . , 3550x which are (directly) connected to the output of an inhibitory node and applying 134 a second set of learning rules to each of the synapses 3550a, 3550b, . . . , 3550x which are (directly) connected to the output of an excitatory node. The first set of learning rules is different from the second set of learning rules, e.g., the learning rules of the first set of learning rules have a longer time constant than the learning rules of the second set of learning rules. Alternatively, the first set of learning rules is the same as the second set of learning rules (e.g., having the same time constant). In some embodiments, there is plasticity in the synapses 3550a, 3550b, . . . , 3550x of each of the inhibitory nodes (as well as each of the excitatory nodes). Thus, each node is made more independent of the other nodes. Moreover, in some embodiments, the sensors 212 are connected/connectable to synapses of one or more network nodes 355 and/or one or more output nodes 365. Furthermore, there is plasticity in these synapses. Moreover, learning 530 (as described herein) may also be applied to these synapses.

In some embodiments, the controller system 400 is or comprises an NN controller and one or more output nodes 365 of the middleware system 300 are connected/connectable to one or more input nodes of the NN controller. The one or more input nodes of the NN controller have synapses. Furthermore, there is plasticity in these synapses. Moreover, learning 530 (as described herein) may also be applied to these synapses.

Furthermore, in some embodiments, each of the one or more network nodes comprises an independent state memory or an independent time constant. Thus, each network node 355 (and each output node 365) is, or comprises, in some embodiments, an independent internal state machine. Furthermore, as each internal state machine one (per network/output node 355, 365) is independent from the other internal state machines (and therefore an internal state machine/network node may have, or is capable of having, properties, such as dynamic properties, different from all other internal state machines/network nodes), a wider dynamic range, a greater diversity, learning with fewer resources and/or more efficient (independent) learning is achieved. Moreover, in some embodiments, the first system 200 is a telecommunication system, a data communication system, a robotics system, a mechatronics system, a mechanical system, a chemical system comprising electrical sensors and actuators, or an electrical/electronic system. Alternatively, the first system 200 comprises a telecommunication system, a data communication system, a robotics system, a mechatronics system, a mechanical system, a chemical system comprising electrical sensors and actuators, and/or an electrical/electronic system. As another alternative, the first system is or comprises soft robotics, i.e., the first system 200 is/comprises robots/robotics composed of or comprising compliant materials, such as foot pads to absorb shock or springy joints to store/release elastic energy. In soft robotics, there may be dependencies between sensors. The middleware 300 is particularly well suited for identifying dynamic modes in a system, in which there is dependencies between sensors.

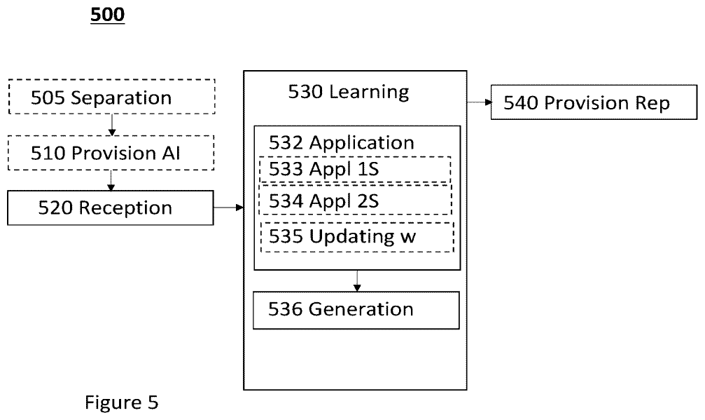

Returning to FIG. 1A, the middleware system 300 comprises one or more network nodes 355. Furthermore, in some embodiments, the middleware system 300 comprises one or more output nodes 365. Each of the one or more output nodes 365 is connected to some or all of the one or more network nodes 355. Furthermore, each of the one or more output nodes 365 is connected or connectable to a respective actuator 214 (of the first system 200). Moreover, each of the one or more network nodes 355 and/or each of the one or more output nodes 365 are connected or connectable to one or more (or all) of the sensors 212 (of the first system 200). The middleware system 300 is configured to receive sensory feedback indicative of the dynamics and/or the time constants of the first system from the sensors 212. Furthermore, the middleware system 300 is configured to learn a representation of the dynamics and/or the time constants of the first system 200 by applying unsupervised, correlation-based learning to each of the one or more network nodes 355 and/or each of the one or more output nodes 365 and by generating an organization (i.e., by organizing or re-organizing the connections between nodes) of the one or more network nodes 355 and/or each of the one or more output nodes 365 in accordance with the received sensory feedback. Moreover, the middleware system 300 is configured to provide a representation of the dynamics and/or the time constants of the first system 200 to the controller system 400. In some embodiments, the middleware system 300 comprises controlling circuitry. The controlling circuitry is configured to cause reception 520 (shown in FIG. 5) of sensory feedback indicative of the dynamics and/or the time constants of the first system 200. Furthermore, the controlling circuitry is configured to cause learning 530 of a representation of the dynamics and/or the time constants of the first system by application 532 of unsupervised, correlation-based learning to each of the one or more network nodes 355 and/or to each of the one or more output nodes 365 and by generation 536 of an organization of the one or more network nodes 355 and/or the one or more output nodes 365 in accordance with the received sensory feedback. In some embodiments, learning 530 utilizes self-organizing learning rules (comprised in a unit 370). Moreover, the controlling circuitry is configured to cause provision 540 of a representation of the dynamics and/or the time constants of the first system 200 to the controller system 400.

A controller system 400 is shown in FIG. 1A. The controller system 400 is connected or connectable to the middleware 300. Furthermore, the controller system 400 receives or is configured to receive a representation of the dynamics and/or the time constants of the first system 200 from the middleware system 300. In some embodiments, the controller system 400 receives or is configured to receive sensory feedback, e.g., directly from the one or more sensors 212 or state feedback from the middleware system 300. Moreover, the controller system 400 is configured to learn (404) a representation of dynamic components, such as one or more time constants, of the middleware system 300. Learning rules 420, such as re-enforcement learning rules or model-learning rules, may be applied to the controller system 400 for learning (e.g., during learning 404 described below in connection with FIG. 4). The controller system 400 is configured to generate (compare with 406 described below) one or more control actions for controlling the first system 200 based on the (learnt) representation of the middleware system 300. In some embodiments, the one or more control actions are affecting actuators 214 directly. Alternatively, the control actions are sent to the middleware 300 and the middleware 300 controls the first system 200 in accordance with the control actions received from the controller system 400. Furthermore, in some embodiments, the controller system 400 is further configured to receive (compare with 402 described below) a representation of the dynamics and/or the time constants of the first system 200 from the middleware system 300. The generation of the one or more control actions for controlling the first system 200 is then further based on the representation of the first system 200, i.e., generate (406) one or more control actions is performed in accordance with the representation of the first system 200 (received from the middleware system 300). Moreover, in some embodiments, the first system 200 is a (mechanical) system comprising a plurality of sensors 212 and the information input to a neural domain of the middleware system 300 (from the sensors 212) comprises temporal dynamics information for the plurality of sensors 212. In some embodiments, the controller system 400 is or comprises a model-based controller. Furthermore, in some embodiments, learning/learn (404) a representation of dynamic components of the middleware system 300 comprises reinforcement learning or applying reinforcement learning. Alternatively, or additionally, learning/learn (404) a representation of dynamic components of the middleware system 300 comprises model learning or applying model learning. Furthermore, a second system 490 is provided. The second system 490 comprises the middleware system 300 (as described herein). Moreover, the second system 490 comprises the controller system 400 (as described herein). An activity pattern generator 390 is also shown in FIG. 1A. The activity pattern generator 390 may be comprised by the middleware system 300 (i.e., an internal activity pattern generator) or may be external to the middleware system 300. In some embodiments, the activity pattern generator 390 generates a random sequence or a pre-defined sequence.

FIG. 2 illustrates a network node 355 according to some embodiments. The network node 355 comprises one or more input weights w1, w2, . . . , wx. Furthermore, in some embodiments, the network node 355 comprises one or more input units (or synapses) 3550a, 3550b, . . . , 3550x. Each input unit 3550a, 3550b, . . . , 3550x comprises a respective input weight w1, w2, . . . , wx. The network node 355 receives one or more inputs 3551, 3552, . . . , 355x. One or some of the one or more inputs 3551, 3552, . . . , 355x may be system inputs to the middleware system 300. The one or more inputs 3551, 3552, . . . , 355x are weighted by a respective input weight w1, w2, . . . , wx, thereby obtaining one or more weighted inputs 330a, 330b, . . . , 330x. The weighted inputs 330a, 330b, . . . , 330x are summed or added together (by an adder or a summer 335), thereby obtaining a sum of weighted inputs 330a, 330b, . . . , 330x which is utilized as an intermediate output 3558. Furthermore, in some embodiments, an internal state of the network node 355 is also added together with the weighted inputs 330a, 330b, . . . , 330x, by the adder/summer 335. Moreover, in some embodiments, a non-zero threshold is applied to the intermediate output 3558, by a threshold unit 358, e.g., the intermediate output 3558 is reduced by a threshold value, thereby a (reduced) output 3559 is obtained. Alternatively, a zero threshold value (a threshold value of zero) is applied to the intermediate output 3558.

FIG. 3 illustrates an output node 365 according to some embodiments. The output node 365 comprises one or more input weights wa, wb, . . . , wy. Furthermore, in some embodiments, the output node 365 comprises an input unit (or a synapse) 3650. The input unit 3650 comprises the one or more input weights wa, wb, . . . , wy. The output node 365 receives one or more inputs 3651, 3652, . . . , 365x. The one or more inputs 3651, 3652, . . . , 365x are weighted by a respective input weight wa, wb, . . . , wy, thereby obtaining one or more weighted inputs 340a, 340b, . . . , 340x. The weighted inputs 340a, 340b, . . . , 340x are summed or added together (by an adder or a summer 345), thereby obtaining a sum of weighted inputs 340a, 340b, . . . , 340x, which sum is utilized as an intermediate output 3658. Furthermore, in some embodiments, an internal state of the output node 365 is also added together with the weighted inputs 340a, 340b, . . . , 340x, by the adder/summer 345. Moreover, in some embodiments, a non-zero threshold value is applied to the intermediate output 3658, by a threshold unit 368, e.g., the output intermediate 3658 is reduced by a threshold value, thereby a (reduced) output 3659 is obtained. Alternatively, a zero threshold value (a threshold value of zero) is applied to the intermediate output 3658. The output 3659 of one or more (e.g., all) output nodes 365 is utilized as a system output for the middleware 300.

The middleware system 300 comprises two or more network nodes 355 and optionally one or more output nodes 365. If the middleware system 300 does not comprise any output nodes 365 then one or more network nodes may function as output nodes. Furthermore, the network nodes 355 and optionally the output nodes 365 are connected to each other (e.g., all nodes are connected to each other). Thus, the middleware system 300 comprises connections. Furthermore, as indicated herein the nodes 355, 365 comprises input weights for input signals. Thus, the connections are weighted. One way of organizing the middleware 300 is by adjusting the input weights. In some embodiments, adjusting the input weights comprises setting weights having a value lower than a weight threshold to zero, thereby removing a connection completely (and irreversibly), i.e., pruning is performed. Thereby, the computational burden of the middleware is lowered and/or the middleware can be less complex. Alternatively, adjusting the input weights comprises setting some of the weights to zero, thereby removing a connection completely (but not irreversibly). Furthermore, in some embodiments, the weights are adjusted by the middleware 300 itself, e.g., by the help of self-organizing learning rules contained/comprised in the unit comprising self-organizing learning rules 370. By utilizing self-organizing learning rules or by self-organization in general, no pre-structuring of the middleware/network is needed. However, in some embodiments, pre-structuring of the middleware system 300 is performed. As an example, all gains of the middleware system 300 may initially be set to a random value. As another example, the network nodes 355 may be separated (105) into inhibitory nodes and excitatory nodes. Furthermore, the network is formed as wanted (e.g., without restraints). E.g., the network connectivity can take a shape that is reflective of its inherent dynamic modes, and thereby the network can be more efficiently utilized. I.e., dynamic modes in the plant that has a natural counterpart in the dynamic modes of the network is what the learning will focus on. This is in contrast to, for example, reinforcement learning where there is an arbitrary goal of the learning that may not be suitable for the network at hand. Hence, with reinforcement learning the learning will be more inefficient. Therefore, the network resources may not be sufficient for learning as many different dynamic modes as can be learnt with self-organization.

FIG. 4 illustrates method steps of a method 401 according to some embodiments. The method 401 is for a controller system 400 (as described above). The method 401 comprises, in some embodiments, receiving 402, by the controller system 400, a representation of the dynamics and/or the time constants of the first system 200 from the middleware system 300. In some embodiments, receiving 402 may comprise receiving input from sensors 212 and/or receiving input from one or more nodes of the middleware 300. Furthermore, the method 401 comprises learning 404, by the controller system 400, a representation of dynamic components, such as one or more time constants, of a middleware system 300. The learning 404 comprises, in some embodiments, re-enforcement learning rules or model-learning rules as described above. Furthermore, alternatively, or additionally, the learning 404 comprises utilization of the provided activity injection (as described above). Moreover, the method 401 comprises generating 406, by the controller system 400, one or more control actions for controlling a first system 200 based on the representation of the middleware system 300.

FIG. 5 illustrates method steps implemented in a middleware system 300 according to some embodiments. The middleware system 300 is connected or connectable to a controller system 400 and to a first system 200. The middleware system 300 comprises two or more network nodes 355. In some embodiments, the middleware system 300 comprises one or more output nodes 365, which are separate from the two or more network nodes 355. Furthermore, in some embodiments, the middleware system 300 is configured to provide 510 (or cause provision of) an activity injection to the two or more network nodes 355 and/or the one or more output nodes 365, thereby exciting the actuators 214 of the first system 200. To this end, the middleware system 300 may be associated with (e.g., operatively connectable, or connected, to) a first providing unit (e.g., first providing circuitry, a first provider, or the activity pattern generator 390). Furthermore, the middleware system 300 is configured to receive 520 (or cause reception of) sensory feedback (from the one or more sensors 212; e.g., by the one or more network nodes 355). The sensory feedback is indicative of the dynamics and/or the time constants of the first system 200. To this end, the middleware system 300 may be associated with (e.g., operatively connectable, or connected, to) a first reception unit (e.g., first receiving circuitry, a first receiver, or the one or more network nodes 355). Moreover, the middleware system 300 is configured to learn 530 (or cause learning of) a representation of the dynamics and/or the time constants of the first system 200 by application 532 of unsupervised learning to the middleware system 300 and by generation 536 of an organization of the middleware system 300 in accordance with the received sensory feedback. To this end, the middleware system 300 may be associated with (e.g., operatively connectable, or connected, to) a first learning unit (e.g., first learning circuitry, a first learner, and/or a unit comprising self-organizing learning rules 370), a first applying unit and/or a first generating unit. In some embodiments, before generation 536 of an organization of the middleware system 300 is performed, separation 505 of the network nodes 355 into inhibitory nodes and excitatory nodes is performed (e.g., as an initialization of the middleware system 300). To this end, the middleware system 300 may be associated with (e.g., operatively connectable, or connected, to) a separating unit (e.g., separating circuitry, or a separator). Furthermore, in some embodiments, application 532 of unsupervised, correlation-based learning comprises application 533 of a first set of learning rules to each of the synapses 3550a, 3550b, . . . , 3550x which are connected to an inhibitory node and application 534 of a second set of learning rules to each of the synapses 3550a, 3550b, . . . , 3550x which are connected to an excitatory node. To this end, the middleware system 300 may be associated with (e.g., operatively connectable, or connected, to) first and second application units (e.g., first and second applying circuitry, first and second applicators and/or first and second units, each comprising a set of self-organizing learning rules 370). Furthermore, the middleware system 300 is configured to provide 540 (or cause provision of) a representation of the dynamics and/or the time constants of the first system 200 to the controller system 400. To this end, the middleware system 300 may be associated with (e.g., operatively connectable, or connected, to) a first providing unit (e.g., first providing circuitry, or a first provider, or one or more output nodes 365).

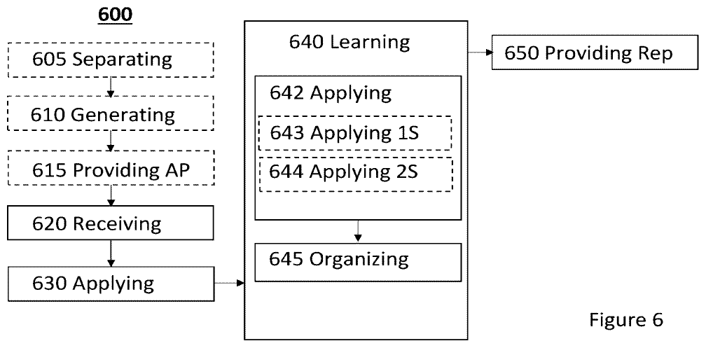

FIG. 6 illustrates method steps of a method 600 according to some embodiments. In some embodiments, the method 600 is computer-implemented. Alternatively, the method 600 is hardware-implemented. The method 600 is a method of providing a representation of temporal dynamics of a first system 200 comprising sensors 212 by utilizing a middleware system 300 connected or connectable to a controller system 400. The middleware system 300 comprises two or more network nodes 355. Furthermore, a first set of the two or more network nodes 355 is connected or connectable to the sensors 212. The method 600 comprises receiving 620 (by the middleware or by the first set of network nodes 355; e.g., continuously over a time period) activity information from the sensors 212. The activity information is indicative of the temporal dynamics of the first system 200. Furthermore, the activity information evolves over time. Moreover, the method 600 comprises applying 630 a set of unsupervised learning rules to each of the one or more network nodes 355. Furthermore, the method 600 comprises learning 640 a representation of the temporal dynamics of the first system 200 by organizing 645 the middleware system 300 in accordance with the received activity information and in accordance with the applied sets of unsupervised learning rules. The method 600 comprises providing 650 the representation of the temporal dynamics of the first system 200 to the controller system 400. In some embodiments, the first system 200 comprises actuators 214 and/or the middleware system comprises an activity pattern generator 390 (or is connected/connectable to an external activity pattern generator 390). In these embodiments, the method 600 comprises generating 610, by the activity pattern generator 390, an activity pattern/injection. Furthermore, the method 600 comprises providing 615 the activity pattern/injection to the actuators 214, thereby exciting the actuators 214 (of the first system 200). Moreover, organizing 645 the middleware system is performed in accordance with the generated activity pattern (as well as in accordance with the received activity information and in accordance with the applied sets of unsupervised learning rules). The embodiments described above for the method 100 are also applicable to the method 600. Thus, all or any of the features/steps of the method 100 may be part of the method 600. This is also reflected in FIG. 6 (e.g., the step applying 642 unsupervised learning to the middleware system 300 corresponds to the step 132 of the method 100, the step applying 643 first set of learning rules corresponds to the step 133 of the method 100, the step applying 644 second set of learning rules corresponds to the step 134 of the method 100, and the step separating 605 the network nodes 355 into inhibitory nodes and excitatory nodes corresponds to the step 105 of the method 100, all described above).

The actuators are controllable by two physically and temporally separate mechanisms:

The activity pattern generator 390 drives them directly or indirectly during the self-organizing, unsupervised learning phase for the middleware 300.

The controller drives them indirectly through the middleware 300 when performing useful (control) activities and when learning to make such movements by trial-and-error reinforcement or model learning within the controller and its connections to the middleware 300.

In some embodiments, the invention requires a dynamic (first) system in which actuators (of the first system) change the state of a plant/system and sensors provide state/sensory feedback (in accordance with the state change accomplished by the actuators or in accordance with movement of the actuators). The activity pattern generator 390 is utilized in a preferred embodiment that facilitates self-organization of the middleware 300. However, that process could occur simultaneously with the phase in which the controller generates direct or indirect drive to the actuators 214, i.e., during the reinforcement or model learning phase for the controller.

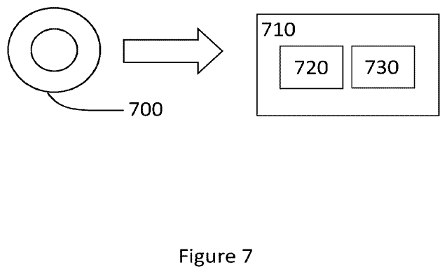

According to some embodiments, a computer program product comprising a non-transitory computer readable medium 700, such as a punch card, a compact disc (CD) ROM, a read only memory (ROM), a digital versatile disc (DVD), an embedded drive, a plug-in card, or a universal serial bus (USB) memory, is provided. FIG. 7 illustrates an example computer readable medium in the form of a compact disc (CD) ROM 700. The computer readable medium has stored thereon, a computer program comprising program instructions. The computer program is loadable into a data processor (PROC) 720, which may, for example, be comprised in a computer 710 or a computing device or a processing unit. When loaded into the data processor 720, the computer program may be stored in a memory (MEM) 730 associated with or comprised in the data processor 720. According to some embodiments, the computer program may, when loaded into and run by the data processor 720, cause execution of method steps according to, for example, one of the method illustrated in FIG. 1 or 6, which is described herein. Furthermore, in some embodiments, there is provided a computer program product comprising instructions, which, when executed on at least one processor of a processing device, cause the processing device to carry out the method illustrated in one of FIG. 1B and FIG. 6. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in one of FIG. 1B and FIG. 6.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

What is claimed is:

1. A computer-implemented method for providing a representation of dynamics and/or time constants of a first system comprising sensors and actuators to a controller system, the method comprising:
performing, by a middleware system, a self-organisation in accordance with sensory feedback received from the first system, the middleware system being connected or connectable to a controller system for the first system, wherein the middleware system comprises a network of two or more network nodes and one or more output nodes, wherein the two or more network nodes are connected to the one or more output nodes, wherein the one or more output nodes are connected or connectable to the actuators of the first system, wherein the two or more network nodes and/or the one or more output nodes are connected or connectable to the sensors of the first system, and wherein the self-organisation is performed responsive to the middleware system:
receiving sensory feedback indicative of the dynamics and/or the time constants of the first system from one or more of the sensors of the first system; and
learning a representation of the dynamics and/or the time constants of the first system, the learning comprising the middleware applying unsupervised, correlation-based learning to the synapses of each one or more network nodes and one or more output nodes of the middleware system, wherein the self-organization of the middleware system separates the network nodes into inhibitory nodes and excitatory nodes, and wherein the method further comprises providing, by the self-organised middleware, the representation of the dynamics and/or the time constants of the first system to the controller system.

2. The method of claim 1, wherein the two or more network nodes form a recursive network or a recurrent neural network.

3. The method of claim 1, further comprising:
providing an activity injection to the network nodes and/or the output nodes, thereby exciting the actuators of the first system.

4. The method of claim 1, wherein the controller system is a neural network controller.

5. The method of claim 1, wherein each of the two or more network nodes and each of the one or more output nodes comprises input weights and wherein generating an organization of the middleware system comprises adjusting the input weights, wherein applying unsupervised, correlation-based learning to the middleware system comprises updating the input weights of each network node and each output node based on correlation of each input of the node with the output of the node.

6. The method of claim 1, wherein each of the one or more network nodes comprises an independent state memory or an independent time constant.

7. The method of claim 1, wherein the first system is one of: a telecommunication system, a data communication system, a robotics system, a mechatronics system, a mechanical system, a chemical system comprising electrical sensors and actuators, or an electrical/electronic system.

8. A computer program product comprising instructions, which, when executed on at least one processor of a processing device, cause the processing device to carry out the method according to claim 1.

9. A non-transitory computer-readable storage medium storing one or more programs configured to be executed by one or more processors of a processing device, the one or more programs comprising instructions which, when executed by the processing device, causes the processing device to carry out the method according to claim 1.

10. A middleware system connected or connectable to a controller system and to a first system comprising sensors and actuators, the middleware system comprising controlling circuitry configured to cause:
reception of sensory feedback indicative of the dynamics and/or the time constants of the first system;
learning of a representation of the dynamics and/or the time constants of the first system by application of unsupervised, correlation-based learning to each of the one or more network nodes and/or to each of the one or more output nodes and generation of an organization of the one or more network nodes and/or the one or more output nodes, the generation comprising separating the network nodes into inhibitory nodes and excitatory nodes in accordance with the received sensory feedback; and
provision of a representation of the dynamics and/or the time constants of the first system to the controller system wherein each of the two or more network nodes of the middleware system comprises one or more synapses, wherein the application of unsupervised, correlation-based learning comprises in each node independently of other nodes in the network:
applying a first set of learning rules to each of the synapses of that node which are connected to the output of an inhibitory node; and
applying a second set of learning rules to each of the synapses of that network node which are connected to the output of an excitatory node, wherein the first set of learning rules is different from the second set of learning rules.

11. A middleware system connectable to a controller system and to a first system comprising sensors and actuators the middleware system comprising:
one or more network nodes; one or more output nodes, wherein each of the one or more output nodes is connected to the one or more network nodes, and wherein each of the one or more output nodes is connectable to a respective actuator, and wherein each of the one or more network nodes and/or each of the one or more output nodes are connectable to a respective sensor; and wherein the middleware system is configured to:
receive sensory feedback indicative of the dynamics and/or the time constants of the first system from the sensors;
learn a representation of the dynamics and/or the time constants of the first system by applying unsupervised, correlation-based learning to each of the one or more network nodes and/or each of the one or more output nodes and generating an organization of the one or more network nodes and/or each of the one or more output nodes in accordance with the received sensory feedback, the generating comprising separating the network nodes into inhibitory nodes and excitatory nodes; and
provide a representation of the dynamics and/or the time constants of the first system to the controller system wherein each of the two or more network nodes of the middleware system comprises one or more synapses, wherein the applying of unsupervised, correlation-based learning comprises in each node independently of other nodes in the network:
applying a first set of learning rules to each of the synapses of that node which are connected to the output of an inhibitory node; and
applying a second set of learning rules to each of the synapses of that node which are connected to the output of an excitatory node, wherein the first set of learning rules is different from the second set of learning rules.

12. A controller system configured to:
learn a representation of dynamic components of the middleware system of claim 1;
generate one or more control actions for controlling a first system based on the representation of the middleware system.

13. The controller system of claim 12, further configured to:
receive a representation of the dynamics and/or the time constants of the first system from the middleware system and wherein the generation of one or more control actions for controlling the first system is further based on the representation of the first system.

14. The controller system of claim 12, wherein:
the first system is a mechanical system comprising a plurality of sensors; and
the information input to the neural domain of the middleware system comprises temporal dynamics information for the plurality of sensors.

15. The controller system of claim 12, comprising:
a model-based controller or a neural network controller.

16. A computer-implemented method of providing a representation of temporal dynamics of a first system comprising sensors by utilizing a middleware system connected or connectable to a controller system, the middleware system comprising two or more network nodes, wherein a first set of the two or more network nodes are connectable to the sensors, the method comprising:
receiving activity information from the sensors indicative of the temporal dynamics of the first system, wherein the activity information evolves over time;
applying a set of unsupervised learning rules to each of the one or more network nodes;
learning a representation of the temporal dynamics of the first system by organizing the middleware system in accordance with the received activity information and in accordance with the applied sets of unsupervised learning rules, wherein organizing the middleware system comprises separating the network nodes into inhibitory nodes and excitatory nodes; and
providing the representation of the temporal dynamics of the first system to the controller system, wherein each of the network nodes comprises one or more synapses, wherein applying a set of unsupervised learning rules to each of the one or more network nodes comprises in each node independently of other nodes in the network:
applying a first set of learning rules to each of the synapses of that network node which are connected to the output of an inhibitory node; and
applying a second set of learning rules to each of the synapses of a network node which are connected to the output of an excitatory node, wherein the first set of learning rules is different from the second set of learning rules.
